(19) United States
(12) Patent Application Publication
(10) Pub. No.: US 2021/0374228 A1
(43) Pub. Date: Dec. 2, 2021

(54) SLEEP STATES DETECTIONS

(71) Applicant: HEWLETT-PACKARD DEVELOPMENT COMPANY, L.P., SPRING, TX (US)

(72) Inventor: STANLEY HYOJUN PARK, SPRING, TX (US)

(21) Appl. No.: 16/652,809

(22) PCT Filed: Jan. 5, 2018
(86) PCT No.: PCT/US2018/012551

§ 371 Date: Apr. 1, 2020

(51) Int. Cl. G06F 21/51; G06F 21/44; G06F 11/30

(52) U.S. Cl. CPC G06F 21/51; G06F 11/3062; G06F 21/44

(57) ABSTRACT

Example Implementations relate to sleep states detections. For example, a computing device may include a processor and a controller. The controller may track a sleep state of the computing device based on a state of a sleep signal received at the controller from the processor, detect a change in a state of a reset signal received at the controller from the processor, determine, responsive to detecting the change in the state of the reset signal, a most recent sleep state of the computing device, and determine, based on the determined most recent sleep state, whether to modify a security feature of the computing device.

### BACKGROUND

A computing device may support a plurality of sleep states. The plurality of sleep states may be utilized by the computing device to manage power consumption by the computing device.

### BRIEF DESCRIPTION OF THE DRAWINGS

FIG. 1 illustrates an example of a device for sleep states detections consistent with the disclosure.

FIG. 2 illustrates an example of a flow diagram of sleep states detections consistent with the disclosure.

FIG. 3 illustrates a diagram of an example of a non-transitory computer readable medium and processing resource for sleep states detections consistent with the disclosure.

FIG. 4 illustrates a diagram of an example of a non-transitory computer readable medium and processing resource for sleep states detections consistent with the disclosure.

### DETAILED DESCRIPTION

Advanced Configuration and Power Interface (ACPI) provides an open standard that computing devices may use to perform power management. The ACPI defines a plurality of sleep states that may be utilized to manage power consumption by the computing device.

In some examples, six distinct sleep states (“Sx”) may be supported by and/or utilized by a computing device. An S0 sleep state may include a working mode and/or a modern (non S1-S3) standby mode of operation for a computing device. For example, the S0 sleep state may include a mode of operation where the computing device is fully operational and components of the computing device that are being utilized may be supplied power to a full power threshold. However, some components that are not being utilized when operating in an S0 sleep state may save power by entering a lower power consumption mode. For example, a display of the computing device may be powered off when no input to the device has occurred for a period of time while operating in the S0 state. However, background tasks may continue to run. However, in the S0 mode the computing device may be fully operational while operating in the S0 state. For example, a processing resource such as a central processing unit (CPU) may be executing instructions.

A S1 sleep state may include a mode of operation whereby the computing device appears to be off. While operating in an S1 sleep state the CPU may be stopped from executing instructions, the random access memory (RAM) may be refreshed, and the computing device may be operating in a low power mode consuming less power than in the S0 state (e.g., five to thirty watts of power consumption), The power supply to the CPU and to the RAM may be maintained. The CPU clock may be off and bus clocks may be stopped. Resuming to S0 from S1 may take less than two seconds. While operating in the S1 sleep state, some components of the computing device such as a keyboard, local area network (LAN), and or USB component may remain powered so that the computing device may resume to S1 rapidly. Additionally, control of software applications on the computing device may restart where the control left off when resuming from the S1 sleep state to S0 sleep state and all device hardware contexts may be retained and maintained by the hardware during operation in the S1 sleep state.

A S2 sleep state may include a mode of operation whereby the CPU is off, RAM is refreshed, and the computing device is running in a lower power mode than S1 and in a higher power mode than S3. When operating in the S2 sleep state the dirty cache of the computing device may be flushed to the RAM and the contents of the system cache may be lost when the processor loses power. When operating in the S2 sleep state the bus clocks of the computing device may be stopped and some buses may even lose power, After resumption from S2, software control may start from the CPU's reset vector. Resuming to S0 from S2 make take two or more seconds and/or may be greater than or equal to the hardware latency for S1. During operation in the S2 sleep state the CPU context and system cache contents may be lost.

A S3 sleep state may include a mode of operation where the CPU is off and the RAM is in a slow refresh. Power consumption by the device operating in the S3 state may be lower than when it is operating in S2 sleep state but higher than when it is operating in S4 sleep state. In addition to the CPU being off, some of the microchips on the motherboard of the computing device may be off. Resumption from S3 may include software control starting from the CPU's reset vector. The device memory may be the memory that is retained while the CPU context, cache contents, and chipset context may be lost while in S3.

A S4 sleep state may include a mode of operation characterized as hibernation. When operating in a S4 sleep state, the hardware of the computing device may be off and the system context may be saved as a temporary hibernation file (e.g., an image of the device memory) in persistent memory before the computing device enters S4 operation mode. Upon resumption, a loader may read the hibernation file and jump to the computing devices previous pre-hibernation context. When operating in sleep states S1-S3, if a computing device loses all AC or battery power, the hardware context of the computing device may be lost and the computing device may reboot to return to S0 sleep state, A computing device operating in S4 sleep state may restart from its previous location even after it loses its battery or AC power since the operating system context is retained in the hibernation file, Power consumption of the computing device may be below five watts and in some examples the computing device may use no power with the exception of a trickle current.

An S5 sleep state may include a mode of operation characterized as off. Operating in a S5 sleep state may include the CPU and hardware components being powered off. Operating in an S5 sleep state may include a power supply unit still supplying power to the power button of the computing device to allow the computing device to return to S0 sleep state when the power button is actuated. However, resumption from operation in the S5 sleep state may include a full reboot and no previous content may be retained.

Computing devices may be the target of cyberattacks. Cyberattacks may include malicious attempts to steal, modify, monitor, and/or destroy a targeted computing device by exploiting a susceptible computing device and/or a susceptible portion of executable instructions stored on the computing device. In some examples, the cyberattacks may include instructions executable by the processing resource to achieve the malicious goal. For example, a cyberattack may include computer viruses, worms, Trojan horses, ransomware, spyware, adware, scareware, and/or other malicious instructions to modify the operation of the computing device.

A mode of operation of a computing device and/or resumption from a mode of operation of a computing device may interfere with cybersecurity measures that function to prohibit and/or impeded cyberattacks on the computing device. For example, a cybersecurity measure may utilize authentication protocols to authenticate components of the computing device and/or communication between the components of the computing device. However, the authentication protocols may rely on the operating system (O/S) of the computing device and/or the basic input output system (BIOS) of the computing device to determine when such authentication should be implemented based on the O/S and BIOS tracking restarts. However, The 0/S and the BIOS are executed by a processing resource such as a processing chipset (e.g., CPU) of the computing device and are therefore exposed to executable instructions such as the malicious executable instructions of a cyberattack. As such, the CPU, O/S, and the BIOS are themselves susceptible to manipulation in a manner that circumvents the authentication protocols.

In contrast, examples of the disclosure include a computing device for sleep detections. The computing device may include a processor and a controller. The controller may include a controller to detect a change in a state of a reset signal received at the controller from the processor, determine, responsive to detecting the change in the state of the reset signal, a most recent sleep state of the computing device, and determine, based on the determined most recent sleep state, whether to modify a security feature of the computing device.

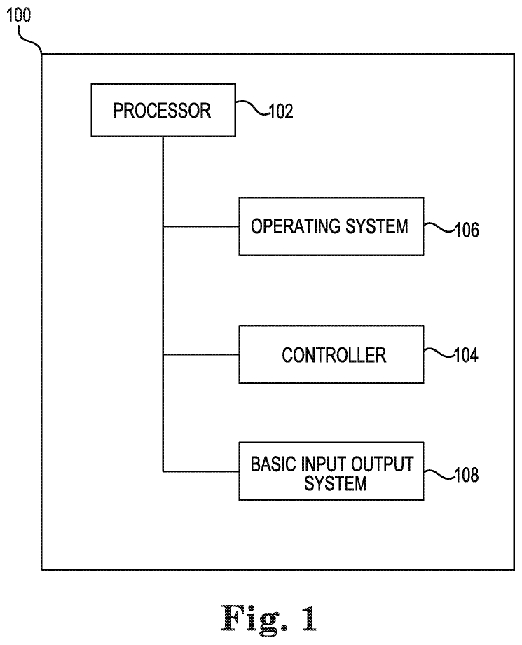

FIG. 1 illustrates an example of a device 100 for sleep states detections consistent with the disclosure. The device 100 may include a computing device. The device 100 may include a mobile computing device such as a laptop computing device, a tablet computing device, a smartphone, a mobile smart device, etc. The device 100 may include a desktop computing device.

The device 100 may include a processor 102. The processor 102 may include a CPU, a semiconductor based microprocessor, and/or other hardware devices suitable for retrieval and execution of instructions stored in non-transitory computer-readable medium. The processor 102 may fetch, decode, and/or execute instructions. As an alternative or in addition to retrieving and executing instructions, processor 102 may include an electronic circuit that includes electronic components for performing the functionality of instructions. The processor 102 may be connected to a bus. The processor 102 may fetch instructions and/or may transmit signals utilizing the bus.

The processor 102 may utilize signals to communicate changes in hardware states and/or operation modes of the computing device 100 across a shared bus. The processor may adjust the state of the signals in order to communicate specific hardware states and/or operation modes. For example, a processor 102 may set a signal communicated across a bus to a low state to communicate that the signal is active. A processor 102 may set the same signal to a low state to communicate that the signal is inactive or not asserted. For example, where the signal is utilized to communicate that the computing device is operating in or transitioning to operating in a specific operational state, setting the signal to low may indicate that the computing device is operating in that specific operational state and setting the signal to high may indicate that the device is not operating in that specific operation state.

The processor 102 may set a signal to high or low based on instructions from other components of the device 100 such as the O/S 106, the BIOS 108, a controller 104, a power button, etc. Upon detecting that a signal is set to high or set to low or has changed between being set to high and set to low, components of the computing device 100 may perform processes or cause processes to be performed that accord with the state change signaled by the state of the hardware signal.

For example, the processor 102 may set a sleep signal (SLP_Sx #) to high in order to signal to other components on the bus that the computing device 100 is entering and/or operating in a corresponding sleep state. For example, the processor 102 may set a signal associated with an S3 sleep state (e.g., a SLP_S3 signal) to a low state from a high state to signal to other components on the bus that the computing device 100 is entering and/or operating in an S3 sleep state from an S0 sleep state. The processor may set the SLP_S3 signal back to the high state in order to signal to the other components on the bus that the computing device 100 is resuming from an S3 sleep state to an S0 sleep state.

The processor 102 may set a signal associated with an S4 sleep state and/or and S5 sleep state (e.g., SLP_S4 signal) to a low state from a high state in order to signal to other components on the bus that the computing device 100 is entering and/or operating in a S4 or S5 sleep state from an S0 sleep state. The processor 102 may set the SLP_S4 signal back to a high state from a low state to signal to the other components on the bus that the computing device 100 is resuming from the S4 or S5 sleep state to an S0 sleep state.

The processor 102 may set a signal associated with a reset of the processor 102 (e.g., low pin count reset signal (LPCRT #), platform reset signal (PLTRST #), etc.) to a low state from a high state in order to signal to other components on the bus that a CPU is entering a reset. The processor 102 may set the reset signals such as LPCRT # or PLTRST # back to high from low to signal to the other components on the bus that the computing device 100 is resuming to an S0 sleep state from a processor 102 reset. However, setting the reset signal such as LPCRT # or PLTRST # from low to high or from high to low may not alone communicate a sleep state that the computing device is in, was in prior to the reset signal being asserted, and/or a trigger of the reset signal. Instead, the reset signal may be a focused communication that the processor 102 is being and/or has been reset.

The computing device 100 may include a controller 104. The controller 104 may be a microcontroller embedded in the architecture of the computing device 100 that is separate from the processor 102. For example, the controller 104 may be an embedded controller (EC) that manages power sequencing for the computing device 100. Alternatively, the controller 104 may include a super input/output (SIO) class of input/output controller integrated circuit that manages power sequencing for the computing device 100.

The controller 104 may include instructions executable by a processing resource of the controller 104. The controller 104 may run separately and independently from the processor 102. The controller 104 may manage a cooling fan speed, may monitor thermal conditions and regulate a fan speed, may manage charging of a battery of the computing device 100, may control light emitting diode (LED) of the computing device 100, and/or may handle management and operation of other components that are on a bus between the processor 102 and a motherboard of the computing device 100.

The controller 104 may be on a same bus as the processor 102. The controller 104 may receive hardware signals asserted by the processor 102. The controller 104 may be able to detect signals such as sleep signals such as SLP_S3 # and/or SLP_S4 # received at the controller 104. For example, the controller 104 may be able to detect a state or a change in state of the sleep signals, such as whether the sleep signals are set to high or set to low or have switched from set to high to set to low or switched from set to low to set to high. The controller 104 may also be able to detect reset signals such as LPCRT # or PLTRST # received at the controller 104. For example, the controller 104 may be able to detect a state or a change in state of the reset signals, such as whether the reset signals are set to high or set to low or have switched from set to high to set to low or switched from set to low to set to high.

The computing device 100 may include a security feature. The security feature may include an authentication protocol. The authentication protocol may include the use of a shared secret between a BIOS 108 of the computing device 100, an operating system 106 of the computing device 100, and the controller 104. For example, the authentication protocol may include the utilization of a cryptographic nonce shared between the BIOS 108 of the computing device 100, an operating system 106 of the computing device 100, and the controller 104 and utilized to verify the communication between the BIOS 108 of the computing device 100, the operating system 106 of the computing device 100, and/or the controller 104 of the computing device 100. For example, the controller 104 may verify that the operating system 106 and/or the BIOS 108 have not been modified and/or replaced by a cyberattack. For example, as long as the BIOS 108, operating system 106, and the controller 104 share the same cryptographic nonce they may utilize a common encryption scheme and matching encryption keys. In some examples, communications between the BIOS 108 of the computing device 100, the operating system 106 of the computing device 100, and/or the controller 104 may be verified as genuine from the corresponding source as long as utilization of the shared secret is evidenced in the communication.

The security feature may include utilization of the controller 104 as a trusted anchor in the authentication protocol. Since the controller 104 is not exposed to cyber attacks targeting the operating system 106, the BIOS 108, and/or other instructions executable by the processor 102, the controller 104 may be utilized as a manager of the authentication protocol. Managing the authentication protocol may include distributing shared secrets.

In order to avoid a static shared secret between the BIOS 108, operating system 106, and the controller 104 being discovered and/or exploited by a cyber attack, the controller 104 may refresh and/or replace the shared secret based on a triggering event. For example, when processor 102 of the computing device 100 is reset, then the cryptographic nonce may be refreshed or replaced by the controller 104 and the new cryptographic nonce may be distributed to the BIOS 108 and/or the operating system 106 from the controller 104 upon emerging from the reset.

However, in examples where the reset of the processor 102 of the computing device 100 is a result of the computing device 100 resuming operating from an S3 sleep state, replacing the cryptographic nonce may cause a failure in the authentication protocol. For example, when the computing device 100 begins to resume to a S0 sleep state from the S3 sleep state, the computing device 100 may begin to utilize stored and/or persisting data that allows the computing device 100 to resume operation where it left off. If the cryptographic nonce is erased and/or replaced when the computing device 100 is resuming from the S3 state, the computing device 100 may not be able to utilize such data and the computing device 100 may fail to resume operation where it left off prior to entering S3 sleep state operation. The controller 104 may avoid such failures utilizing the sleep state tracking described below.

In other examples the security feature may include a heartbeat or watchdog timer of the computing device 100. For example, the controller 104 may utilize a timer that monitors the occurrence and/or execution of various benchmark computational events (e.g., applications starting up, applications closing, instructions being executed, etc.) to determine whether a portion of the operating system 106 and/or the BIOS 108 has been attacked and/or modified. For example, if the benchmark computational events do not occur within specific times, then the operating system 106 and/or the BIOS 108 may be considered to have been modified and a shutdown may result. The controller 104 may reset the timer in response to the reset of the processor 102 of the computing device 100. As a result, the computing device 100 may be expected to hit the benchmarks associated with restarting from an S0 sleep state, an S4 sleep state, and/or an S5 sleep state despite these benchmarks not being present in a resume from the S3 sleep state.

Therefore, as with the cryptographic nonce example, in examples where the reset of the processor 102 of the computing device 100 is a result of the computing device 100 resuming from operating in an S3 sleep mode, resetting the timer may cause a failure in the authentication protocol. For example, when resuming from an S3 sleep state, the computing device 100 may resume with its prior computation events instead of following the timed sequence of expected computation benchmarks that occur when not resuming such as in a restart from an S0 sleep state, a S4 sleep state, or a S5 sleep state. The controller 104 may avoid such failures utilizing the sleep state tracking described below.

The controller 104 may track a sleep state that the computing device 100 is operating in. The controller 104 may track the sleep state based on a detected state of a sleep state signal received at the controller 104. In an example, the controller 104 may include instructions executable to operate as a state machine logging the most recent detected sleep state and/or state of a sleep state signal.

The controller 104 may track a most recent sleep state of the computing device 100 by tracking whether a particular type of sleep signal associated with a specific sleep state has been set to high, set to low, or switched from set to high to set to low or switched from set to low to set to high. For example, the controller 104 may detect that a SLP_S3 # signal was set to high and that a SLP_S4 # was also set to high. As such, the controller 104 may log those signal states and/or that the most recent sleep state of the computing device 100 was a S0 working mode sleep state.

In another example, the controller 104 may detect that a SLP_S3 # signal is set to low and/or was switched from set to high to set to low while the SLP_S4 # signal remained set to high. As such, the controller 104 may log those signal states and/or that the most recent sleep state of the computing device 100 was the S3 standby sleep state.

In another example, the controller 104 may detect that a SLP_S4 # signal is set to low and/or was switched from set to high to set to low. The SLP_S4 # signal may be set to low while the SLP_S3 # is set to low, but since the SLP_S4 # signal is asserted by the processor 102 when the computing device 100 is transitioning to a S4 sleep state the controller 104 may log those signal states and/or that the most recent sleep state of the computing device 100 was a S4 or S5 hibernation sleep state.

By tracking the most recent sleep state of the computing device 100 the controller 104 may always be aware of and/or have a record of the most recent sleep state of the computing device 100 accessible without utilizing instructions of the BIOS 108 and/or the operating system 106, without utilizing the processor 102, and/or without utilizing data stored in a memory resource susceptible to modification through cyber attack, That is, the most recent signal states and/or the most recent sleep state of the computing system 100 may be stored at the controller 104.

The controller 104 may detect a change in a state of a reset signal received at the controller 104 from the processor 102. For example, the controller 104 may detect a change in the state of a PLTRST # signal and/or a LPCRT # signal signaling that the processor 102 is being reset. The controller 104 may detect that the reset signal is set to low from set to high or is set to high from set to low. Detecting the change in the state of the reset signal may indicate to the controller 104 that the processor 102 has been reset and that the security feature may be modified to an updated security feature to be shared with the operating system 106 and/or the BIOS 108.

The controller 104 may determine, responsive to detecting the change in the state of the reset signal, a most recent sleep state of the computing device 100. A most recent sleep state of the computing device 100 may include a sleep state that the computing device 100 was entering into and/or operating in immediately before the reset signal was changed from set to high to set to low or changed from set to low back to set to high. The most recent sleep state of the computing device 100 may include a sleep state that led to the reset of the processor 102. The most recent sleep state of the computing device 100 may include a sleep state that the computing device 100 was operating in immediately prior to the computing device 100 reentering an S0 sleep state following the reset. The most recent sleep state may be determined by referencing the most recent sleep state stored at the controller 104 and/or the most recent state of a sleep signal stored at the controller 104.

The controller 104 may determine, based on the determined most recent sleep state, whether to modify the security feature of the computing device 100. For example, the controller 104 may determine that a most recent sleep state of the computing device 100 is an S3 sleep state based on tracking the SLP_S3 # sleep signal being set to low from set to high while the SLP_S4 # signal stayed set to high. Responsive to determining that the most recent sleep state was an S3 sleep state, the controller 104 may determine that the security feature will not be modified. For example, the controller 104 may continue to utilize a previously established cryptographic nonce to complete a verification of a communication between the BIOS 108, the operating system 106, and/or the controller 104 responsive to determining the most recent sleep state is the S3 sleep state.

As described above, deleting and/or modifying the previously established cryptographic nonce may cause a failure in the authentication protocol since the BIOS 108 and/or the operating system 106 may continue to utilize the unmodified previously established cryptographic nonce as they resume where they left off from the S3 sleep state. As such, identifying that the computing device 100 was most recently operating in the S3 standby sleep state may prevent such a failure by ensuring that the controller 104 continues to utilize the unmodified previously established cryptographic nonce. The controller 104 may make such a determination and continue to utilize the unmodified previously established cryptographic nonce without referencing a portion of the operating system 106, a portion of the BIOS 108, the processor 102, and/or data stored on a memory resource exposed to cyber attacks. Instead, the controller 104 may make such a determination based on data (e.g., such as a state) stored at the controller 104.

In another example, the controller 104 may determine that a most recent sleep state is an S4 sleep state or an S5 sleep state based on tracking the SLP_S4 # sleep signal being set to low from set to high. Responsive to determining that the most recent sleep state was an S4 sleep state or S5 sleep state, the controller 104 may determine that the security feature will be modified. For example, the controller 104 may modify, responsive to determining the most recent sleep state is the S4 sleep state or S5 sleep state, a previously established cryptographic nonce and distribute the modified cryptographic nonce to the BIOS 108 and/or the operating system 106 of the computing device 100. The controller 104 may utilize the modified cryptographic nonce to complete a verification of a subsequent communication between the BIOS 108, the operating system 106, and/or the controller 104. The BIOS 108 and/or the operating system 106 may begin to utilize the modified cryptographic nonce in encrypting communication.

The controller 104 may make the determination to modify and/or distribute the modified cryptographic nonce without referencing a portion of the operating system 106, a portion of the BIOS 108, the processor 102, and/or data stored on a memory resource exposed to cyber attacks. Instead, the controller 104 may make such a determination based on data (e.g., such as a state) stored at the controller 104.

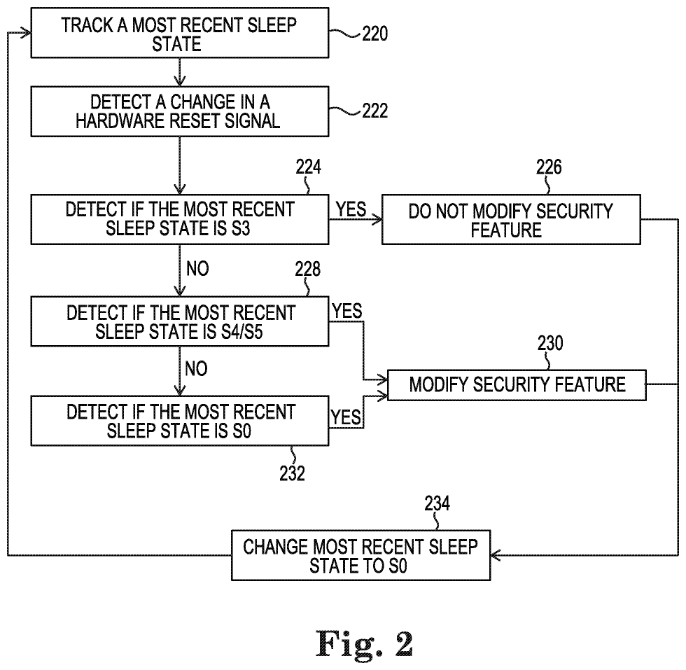

FIG. 2 illustrates a flow diagram of controller operations for sleep states detections in a computing device consistent with the disclosure. At 220, the controller may track a most recent sleep state of the computing device. The controller may track the most recent sleep state by updating the most recent sleep state each time the controller detects a change in the state of particular types of hardware sleep signals corresponding to respective sleep states. The most recent sleep state may be stored at and referenced from the controller.

At 222, the controller may detect a change in a hardware reset signal. For example, the controller may detect that a processor has set the hardware reset signal from a low state to a high state.

At 224, the controller may detect if the most recent sleep state of the computing device is a S3 sleep state. If the most recent sleep state is a S3 sleep state then the controller may proceed to 226.

At 226, the controller may determine not to modify a security feature. If the most recent sleep state is not a S3 sleep state then the controller may proceed to 228.

At 228, the controller may detect if the most recent sleep state is a S4 sleep state or a S5 sleep state. If the most recent sleep state is a S4 sleep state or a S5 sleep state then the controller may proceed to 230.

At 230, the controller may determine to modify the security feature. Conversely, if the most recent sleep state is not a S4 sleep state or S5 sleep state then the controller may proceed to 232.

At 232, the controller may detect if the most recent sleep state is a S0 sleep state. If the most recent sleep state is a S0 sleep state then the controller may proceed to 230.

At 230, the controller may determine to modify the security feature. Regardless of whether the security feature is modified (e.g., at 230) or not modified (e.g., 226) the controller may proceed to 234.

At 234, the controller may change the stored indication of the most recent sleep state to an indication of a S0 sleep state as the most recent sleep state. The controller may proceed back to 220 to track the most recent sleep state,

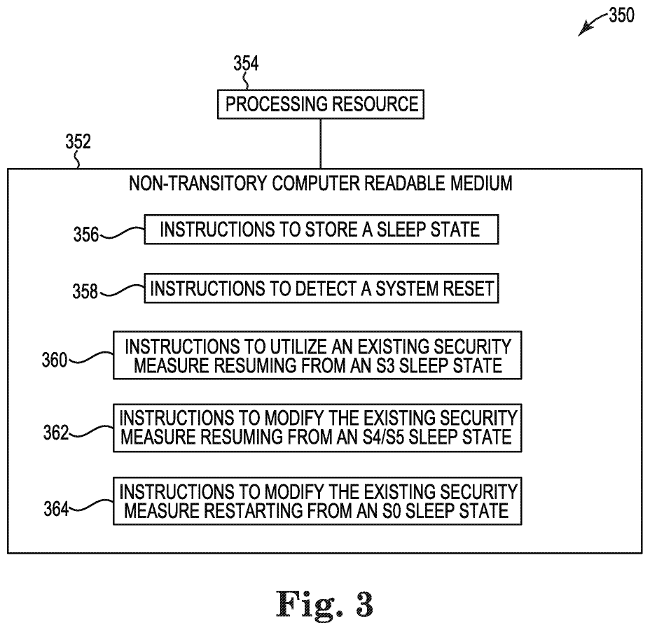

FIG. 3 illustrates a diagram 350 of an example of a non-transitory computer readable medium 352 and processing resource 354 for sleep states detections consistent with the disclosure. In some examples, the processing resource 354 may include a processing resource of the controller (e.g., controller 104 in FIG. 1) that is separate from a central processing resource of a computing device. The non-transitory computer readable medium 352 can be used to store instructions (e.g. 356, 358, 360, 362, 364, etc.) executed by the processing resource 354 to perform operations as described herein. A processing resource 354 may execute instructions stored on the non-transitory computer readable medium 352. The non-transitory computer readable medium 352 may be any type of volatile or non-volatile memory or storage, such as random access memory (RAM), flash memory, read-only memory (ROM), storage volumes, a hard disk, or a combination thereof. In some examples, the non-transitory computer readable medium 352 may include a memory resource of the controller (e.g., controller 104 in FIG. 1) that is separate from a memory resource of a computing device utilized by a CPU of the computing device.

The non-transitory computer readable medium 352 may store instructions 356 executable by the processing resource 354 to store an indication of a most recent sleep state of the computing device. The most recent sleep state of the computing device may be stored at a controller. For example, the most recent sleep may be saved as one of a plurality of states at the controller.

The most recent sleep state of the computing device may be determined based on the state of sleep signals received at the controller from the processor. For example, the controller may monitor a state (e.g., set to high, set to low, etc.) of each of a plurality of sleep hardware signals detected at the controller. The controller may monitor the state of the plurality of hardware signals by detecting the state and/or changes of the state of the plurality of hardware signals received at the controller across a bus shared with a processor of the computing device.

For example, the controller may detect and store on the controller a change in the state of an SLP_S3 # signal, a change in the state of an SLP_S4 # signal, and/or a maintenance of a signal state of the SLP_S3 # or SLP_S4 # signal. In an example, the controller may monitor the state of each of the plurality of sleep hardware signals by detecting a change of the state of each of the plurality of sleep hardware signals from a high state to a low state after the system reset hardware signal changes to the low state and before the system reset hardware signal changes from the low state to the high state.

In an example, the controller may detect and store an indication that the computing device was most recently, prior to a system reset hardware signal change, operating in or entering a S3 sleep state. The controller may detect and store such an indication when it detects that an SLP_S3 # sleep signal was set to low while an SLP_S4 # sleep signal remained set to high immediately prior to the system reset hardware signal change.

In another example, the controller may detect and store an indication that the computing device was most recently, prior to a system reset hardware signal change, operating in or entering a S4 sleep state or a S5 sleep state. The controller may detect and store such an indication when it detects that an SLP_S4 # sleep signal was set to low immediately prior to the system reset hardware signal change.

In yet another example, the controller may detect and store an indication that the computing device was most recently, prior to a system reset hardware signal change, operating in or entering a S0 sleep state. The controller may detect and store such an indication when it detects that an SLP_S3 # sleep signal remained set to high while the SLP_S4 # sleep signal also remained set to high immediately prior to the system reset hardware signal change.

The non-transitory computer readable medium 352 may store instructions 358 executable by the processing resource 354 to detect, at the controller, a change of a state of a system reset hardware signal. The controller may detect the change in the state of the system reset hardware signal by monitoring the state and/or changes in the state of the system hardware signal received at the controller across a bus shared with the processor of the computing device.

The controller may detect a change in the state of the system reset hardware signal from a low state to a high state. The change in the state of the system hardware signal from a low state to a high state may indicate to the controller that the processor of the computing device has been reset and the computing device will be entering operation in a S0 sleep state.

Detecting the change in the state of the system hardware signal from a low state to a high state may trigger the controller to poll the indication of the most recent sleep state of the computing device. Based on the stored indication of the most recent sleep state of the computing device stored at the controller, the controller may determine whether to modify an existing security measure of the computing device or to continue to utilize the existing security measure of the computing device.

For example, the non-transitory computer readable medium 352 may store instructions 360 executable by the processing resource 354 to utilize an existing security measure of the computing device responsive to determining from the indication of the most recent sleep state that the computing device is resuming to an S0 sleep state from an s3 sleep state. For example, the controller may continue to utilize a cryptographic nonce previously established as a shared secret between the controller, the BIOS, and the operating system as a means of encrypting and/or validating communications there between.

The cryptographic nonce may have been previously established between the controller, BIOS, and operating system during a previous reset prior to the BIOS and/or operating system becoming fully operational after the reset. Continuing to utilize the previously established cryptographic nonce may be an acknowledgement that the computing device is resuming from a standby sleep state and that the BIOS and operating system may, as a consequence of the resume, continue to utilize the previously established cryptographic nonce in resuming from their previous state.

In another example, the non-transitory computer readable medium 352 may store instructions 360 executable by the processing resource 354 to modify the existing security measure of the computing device responsive to determining from the indication of the most recent sleep state that the computing device is resuming to an S0 sleep state from an S4/S5 sleep state. An S4/S5 sleep state may include the computing device operating in an S4 hibernation sleep state or an S5 shutdown sleep state. For the purposes of the determination made by the controller, both the S4 sleep state and the S5 sleep state are identical since they both involve a full shutdown of the processor and the loss of the processor context outside of a hibernation file. As such, the controller may utilize the SLP_S4 # to determine whether the computing device is in the S4/S5 sleep state since more specificity regarding whether the computing device was operating in the S5 sleep state as opposed to S4 sleep state is not relevant to deciding whether or not to modify the existing security measure from the controller's perspective.

Modifying the existing security measure may include determining and distributing a new cryptographic nonce to the operating system and the BIOS. The new cryptographic nonce may be distributed by the controller to the operating system and the BIOS during the process of resuming from the S4 sleep state or S5 sleep state. The new cryptographic nonce may replace the previously established cryptographic nonce and may be utilized to encrypt and validate communications between the operating system, the BIOS, and/or the controller subsequent to the computing device completing a resume to an S0 sleep state from the S4 or S5 sleep state.

In yet another example, the non-transitory computer readable medium 352 may store instructions 362 executable by the processing resource 354 to modify the existing security measure of the computing device responsive to determining from the indication of the most recent sleep state that the computing device is restarting from an S0 sleep state to an S0 sleep state. If the most recent sleep state was an S0 sleep state, the controller may determine that a restart of the computing device has occurred and that the computing device is not resuming to a previous context. As such, a new cryptographic nonce may replace the previously established cryptographic nonce and may be utilized to encrypt and validate communications between the operating system, the BIOS, and/or the controller subsequent to the computing device completing a resume to an S0 state following the restart.

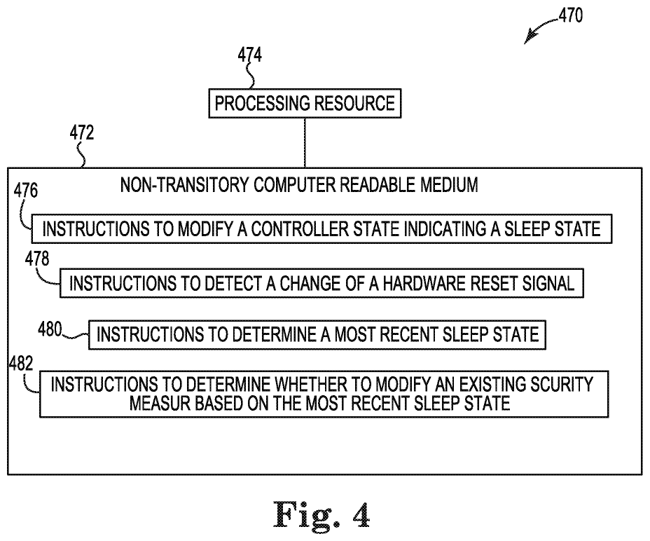

FIG. 4 illustrates a diagram 470 of an example of a non-transitory computer readable medium 472 and processing resource 474 for sleep states detections consistent with the disclosure. In some examples, the processing resource 474 may include a processing resource of the controller (e.g., controller 104 in FIG. 1) that is separate from a central processing resource of a computing device. The non-transitory computer readable medium 472 can be used to store instructions (e.g. 476, 478, 480, 482, etc.) executed by the processing resource 474 to perform operations as described herein. A processing resource 474 may execute instructions stored on the non-transitory computer readable medium 472. The non-transitory computer readable medium 472 may be any type of volatile or non-volatile memory or storage, such as random access memory (RAM), flash memory, read-only memory (ROM), storage volumes, a hard disk, or a combination thereof. In some examples, the non-transitory computer readable medium 47 may include a memory resource of the controller (e.g., controller 104 in FIG. 1) that is separate from a memory resource of a computing device utilized by a CPU of the computing device.

The non-transitory computer readable medium 472 may store instructions 476 executable by the processing resource 474 to modify, responsive to detecting a state change of a hardware sleep signal at a controller in a computing device, a first state of the controller to a second state indicating a particular sleep state. For example, the controller may detect and store indications of particular sleep states as a state of a plurality of states stored at the controller. For example, the controller may include a state machine utilizing states that may be alternated between to indicate a particular sleep state of the computing device.

The controller may monitor which state (e.g., high, low, etc.) each of a plurality of sleep signals are set to that are received at the controller. When a sleep signal changes states from a first state, such as set to high, to a second state, such as set to low, the controller may identify operation of the computing device in the corresponding sleep state.

The controller may, in response to identifying the sleep state based on the sleep signal state change, modify a state stored at the controller. The state of the controller may be modified from a first state identifying operation of the computing device in a first sleep state to a second state identifying operation of the computing device in a second sleep state. For example, the controller may identify that the computing device is operating in an S0 sleep state. The controller may detect a change in the state of a sleep signal associated with an S3 sleep state indicating that the computing device is operating in the S3 sleep state. The controller may modify a first state stored at the controller, indicating that the computing device is operating in a S0 sleep state, to a second state, indicating that the computing device is operating in a S3 sleep state.

The non-transitory computer readable medium 472 may store instructions 478 executable by the processing resource 474 to detect, at the controller, a change of a hardware reset signal to a high state from the processor of the computing device. The controller may monitor the state of hardware reset signals received across the bus at the controller. The controller may detect the change of the hardware reset signal from a low state, indicating that the hardware reset signal is being asserted, to a high state indicating that the hardware reset signal is no longer being asserted, Such a change may indicate to the controller that a reset of a processor on the bus is being initiated and/or has been completed.

The non-transitory computer readable medium 472 may store instructions 480 executable by the processing resource 474 to reference, responsive to detecting the change of the hardware reset signal to the high state, the second state stored at the controller. The second state stored at the controller may be referenced to determine a most recent sleep state that the computing device was in. A most recent sleep state that the computing device was in may include a sleep state that the computing device was operating in immediately prior to the detected change of the hardware reset signal to the high state. The most recent sleep state may communicate the sleep state that the computing device is resuming and/or restarting from as part of the detected hardware reset signal.

The non-transitory computer readable medium 472 may store instructions 482 executable by the processing resource 474 to determine, at the controller, whether to modify an existing security measure based. The determination of whether to modify the existing security measure may be based on the most recent sleep state that the computing device was in prior to the detected change of the hardware reset signal to the high state.

Determining whether to modify the existing security measure may include determining whether to modify and/or issue a modified cryptographic nonce for validation of communications between components of the computing device. For example, resuming from the most recent sleep state may involve resumption of a context of the processor, the BIOS, and/or the operating system from a previous vector. In such examples, the ability of the controller to validate communications from the BIOS and/or operating system may be disrupted by utilizing a different security measure at the controller than a security measure being utilized by the BIOS and/or operating system. As such, a previously established security measure may be utilized to prevent disrupting the ability of the controller to validate communications from the BIOS and/or operating system.

In another example, resuming from the most recent sleep state involves a restart of the computing device without a context of the processor, the BIOS, and/or the operating system from a previous vector. In such examples, an existing security measure may be modified and communicated to the BIOS and the operating system from the controller.

In response to the change of the change of the state of the hardware reset signal to the high state, the controller may again alter the state of the controller indicating the most recent sleep state. For example, the controller may modify the second state of the controller to a third state. In an example, modifying the second state of the controller to the third state includes modifying the second state of the controller to a third state of the controller that indicates the computing device is operating in an S0 power state.

In the foregoing detailed description of the present disclosure, reference is made to the accompanying drawings that form a part hereof, and in which is shown by way of illustration how examples of the disclosure may be practiced. These examples are described in sufficient detail to enable those of ordinary skill in the art to practice the examples of this disclosure, and it is to be understood that other examples may be utilized and that process, electrical, and/or structural changes may be made without departing from the scope of the present disclosure.

What is claimed:

1. A computing device, comprising:
a processor; and
a controller to:
track a sleep state of the computing device based on a state of a sleep signal received at the controller from the processor,
detect a change in a state of a reset signal received at the controller from the processor,
determine, responsive to detecting the change in the state of the reset signal, a most recent sleep state of the computing device, and
determine, based on the determined most recent sleep state, whether to modify a security feature of the computing device.

2. The computing device of claim 1, wherein the sleep signal is a SLP_S3 sleep signal indicating that the computing device is entering an S3 standby sleep state.

3. The computing device of claim 2, the controller to continue to utilize a previously established cryptographic nonce to complete a verification of a communication between a bios of the computing device and the controller responsive to determining the most recent sleep state is the S3 standby sleep state.

4. The computing device of claim 1, wherein the sleep signal is a SLP_S4 sleep signal indicating that the computing device is entering an S4 hibernation sleep state.

5. The computing device of claim 4, the controller to modify, responsive to determining the most recent sleep state is the S4 hibernation sleep state, a previously established cryptographic nonce and distribute a modified cryptographic nonce to a bios of the computing device and to utilize the modified cryptographic nonce to complete a verification of a subsequent communication between the bios and the controller.

6. The computing device of claim 1, wherein the controller includes an embedded controller managing power sequencing for the computing device.

7. The computing device of claim 6, wherein the reset signal is a platform reset (PLTRST #) signal.

8. The computing device of claim 1, wherein the controller includes a super input/output (I/O) class of I/O controller integrated circuit.

9. The computing device of claim 8, wherein the reset signal is a low pin count reset (LPCRST #) signal.

10. A non-transitory computer readable medium containing instructions executable by a processor to cause the processor to:
store, at a controller of a computing device, an indication of a most recent sleep state of the computing device;
detect, at the controller, a change of a state of a system reset hardware signal from a low state to a high state;
utilize an existing security measure of the computing device responsive to determining from the indication of the most recent sleep state that the computing device is resuming from an S3 sleep state;
modify the existing security measure of the computing device responsive to determining from the indication of the most recent sleep state that the computing device is resuming from an S4/S5 sleep state; and
modify the existing security measure of the computing device responsive to determining from the indication of the most recent sleep state that the computing device is restarting from an S0 sleep state.

11. The non-transitory computer readable medium of claim 10, comprising the instructions executable by the processor to cause the processor to determine the most recent sleep state of the computing device by monitoring a state of each of a plurality of sleep hardware signals detected at the controller.

12. The non-transitory computer readable medium of claim 11, comprising the instructions executable by the processor to monitor the state of each of the plurality of sleep hardware signals by detecting a change of the state of each of the plurality of sleep hardware signals from a high state to a low state after the system reset hardware signal changes to the low state and before the system reset hardware signal changes from the low state to the high state.

13. A non-transitory computer readable medium containing instructions executable by a processor to cause the processor to:
modify, responsive to detecting a state change of a hardware sleep signal at a controller in a computing device, a first state of the controller to a second state indicating a particular sleep state;
detect, at the controller, a change of a hardware reset signal to a high state from a processor chipset of the computing device;
reference, responsive to the detected change of the hardware reset signal to the high state, the second state of the controller to determine a most recent sleep state that the computing device was in prior to the detected change of the hardware reset signal to the high state; and
determine, at the controller, whether to modify an existing security measure based on the most recent sleep state that the computing device was in prior to the detected change of the hardware reset signal to the high state.

14. The non-transitory computer readable medium of claim 13, comprising instructions executable by the processor to modify, responsive to the change of the hardware reset signal to the high state, the second state of the controller to a third state.

15. The non-transitory computer readable medium of claim 14, wherein the instructions executable by the processor to modify the second state of the controller to the third state includes instructions executable by the processor to modify the second state of the controller to the third state of the controller, wherein the third state of the controller indicates the computing device is operating in an S0 sleep state.
